(19) United States
(12) Patent Application Publication
(10) Pub. No.: US 2011/0069091 A1
(43) Pub. Date: Mar. 24, 2011

(54) METHOD OF DRIVING LIGHT SOURCE AND DISPLAY APPARATUS FOR PERFORMING THE METHOD

(75) Inventors: Kyoung-Phil Kim, Cheonan-si (KR); Dae-Gwang Jang, Incheon (KR); Sang-Su Han, Seongnam-si (KR); Jung-Hwan Cho, Goyang-si (KR); Po-Yun Park, Asan-si (KR); Hyun-Seok Ko, Seoul (KR); Young-Su Han, Incheon (KR)

(73) Assignee: SAMSUNG ELECTRONICS CO., LTD., Suwon-si (KR)

(21) Appl. No.: 12/696,812

(22) Filed: Jan. 29, 2010

(30) Foreign Application Priority Data
Sep. 23, 2009 (KR) 2009-0089865

(51) Int. Cl. G09G 5/10; G09G 5/00

(52) U.S. Cl. 345/690; 345/204

(57) ABSTRACT

In a method of driving a light source including first through k-th light-emitting blocks (k being a natural number) which provide a display panel with light, the method includes providing identical driving signals to a plurality of light-emitting blocks of the first through k-th light-emitting blocks on which a high gradation image, which has a gradation greater than a predetermined gradation, is displayed.

This application claims priority to Korean Patent Application No. 2009-89865, filed on Sep. 23 20, 2009, and all the benefits accruing therefrom under 35 U.S.C. §119, the content of which in its entirety is herein incorporated by reference.

### BACKGROUND OF THE INVENTION

(1) Field of the Invention

The present invention relates to a method of driving a light source, and a display apparatus for performing the method. More particularly, the present invention relates to a method of driving a light source that provides substantially enhanced display quality, and a display apparatus for performing the method.

(2) Description of the Related Art

Generally, a liquid crystal display (“LCD”) apparatus includes an LCD panel, which displays an image by controlling an optical transmittance of liquid crystal molecules, and a light source module disposed below the LCD panel to provide the LCD panel with light. The LCD panel typically includes a first substrate, on which a pixel electrode and a thin-film transistor which drives the pixel electrode are disposed, and a second substrate, disposed opposite to the first substrate. A liquid crystal layer is disposed between the first substrate and the second substrate.

Recently, efforts have been made in attempts to develop a method of local dimming of a light source in the LCD apparatus. Specifically, in the local dimming method, amounts of light are individually controlled, according to a position thereof, to drive a light source. More specifically, in the method of local dimming of the light source, the light source is divided into a plurality of light-emitting blocks to control the amount of light of each light-emitting block of the plurality of light-emitting blocks, correspondence with dark and light areas of a display area of the LCD panel, which corresponding to the light-emitting blocks. For example, a light-emitting block corresponding to a display area that displays a black image is driven at a low luminance (e.g., is turned off), while a light-emitting block corresponding to a display area that displays a white image is driven at a relatively high luminance (e.g., is not turned off). Thus, in the method of local dimming of the light source, light transmittance of a given pixel is adjusted in accordance with a brightness of the light-emitting blocks, and power consumption may be reduced, while a contrast ratio of a displayed image may be enhanced.

However, in the method of local dimming of the light source, luminance levels of each of the light-emitting blocks are individually controlled, and significant display defects, such as flicker, are generated, due to a luminance level difference between adjacent light-emitting blocks, for example. Thus, there is a need to develop a display apparatus, and method of driving the same, which overcomes at least the above-mentioned deficiencies.

### BRIEF SUMMARY OF THE INVENTION

Exemplary embodiments of the present invention include a method of driving a light source, in which a flickering phenomenon is substantially reduced and/or is effectively eliminated.

Exemplary embodiments of the present invention also provide a display apparatus for performing the method.

According to an exemplary embodiment of the present invention, a method of driving a light source including first through k-th light-emitting blocks (wherein ‘k’ is a natural number) is provided. The first through k-th light-emitting blocks provide a display panel with light. The method includes providing identical driving signals to a plurality of light-emitting blocks of the first through k-th light-emitting blocks on which a high gradation image, which has a gradation greater than a predetermined gradation, is displayed.

According to another exemplary embodiment of the present invention, there is provided a method of driving a light source including first through k-th light-emitting blocks, which provide first through k-th display blocks, respectively, of the display panel with light. The method includes driving a light-emitting block of the first through k-th light-emitting blocks on which a white image is displayed so that a luminance level of a corresponding display block on which the white image is displayed is a minimum white level. When a white image is displayed on one of the first through k-th display blocks and a black image is displayed on remaining display blocks of the first through k-th display blocks, the minimum white level is a luminance level of the corresponding display block on which the white image is displayed.

According to still another exemplary embodiment of the present invention, a display apparatus includes a display panel, a light source module and a light source driving part. The display panel displays an image. The light source module includes first through k-th light-emitting blocks, which provide first through k-th display blocks, respectively, of the display panel with light. The light source driving part provides identical driving signals to a plurality of light-emitting blocks of the first through k-th light-emitting blocks on which a high gradation image, which has a gradation greater than a predetermined gradation, is displayed.

Thus, according to exemplary embodiments of the present invention, a real luminance level of a display block that displays a white image is uniform with respect to a minimum white level, and a flickering phenomenon is thereby effectively prevented. Moreover, a luminance level is decreased during a full white driving period, and power consumption required for driving the light source is therefore substantially reduced.

### BRIEF DESCRIPTION OF THE DRAWINGS

The above and other aspects and/or features of the present invention will become more readily apparent by describing in further detail exemplary embodiments thereof with reference to the accompanying drawings, in which:

FIG. 1 is an exploded perspective view of an exemplary embodiment of a display apparatus according to the present invention;

FIG. 2 is a block diagram of the display apparatus of FIG. 1;

FIGS. 3A and 3B are graphs of dimming level versus light-emitting block numbers showing luminance levels of a pattern image displayed on the display apparatus of FIG. 1;

FIGS. 4A, 4B and 4C are graphs of dimming level versus light-emitting block numbers, and duty ratios for corresponding driving signals, illustrating an exemplary embodiment of a method of driving a light source module according to the present invention;

FIGS. 5A, 5B and 5C are graphs of dimming level versus light-emitting block numbers, and duty ratios for corresponding driving signals, illustrating another exemplary embodiment of a method of driving a light source module according to the present invention;

FIGS. 6A, 6B and 6C are graphs of dimming level versus light-emitting block numbers, and duty ratios for corresponding driving signals, illustrating another exemplary embodiment of a method of driving a light source module according to the present invention;

FIGS. 7A, 7B and 7C are graphs of dimming level versus light-emitting block numbers, and duty ratios for corresponding driving signals, illustrating yet another exemplary embodiment of a method of driving a light source module according to the present invention;

FIG. 8 is a block diagram of another exemplary embodiment of a dimming driving part according to the present invention;

FIG. 9 is an exploded perspective view of another exemplary embodiment of a display apparatus according to the present invention;

FIG. 10 is a block diagram of the display apparatus of FIG. 9;

FIG. 11 is an exploded perspective view of still another exemplary embodiment of a display apparatus according to the present invention; and

FIG. 12 is a block diagram of the display apparatus of FIG. 11.

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the present invention will be described in further detail with reference to the accompanying drawings.

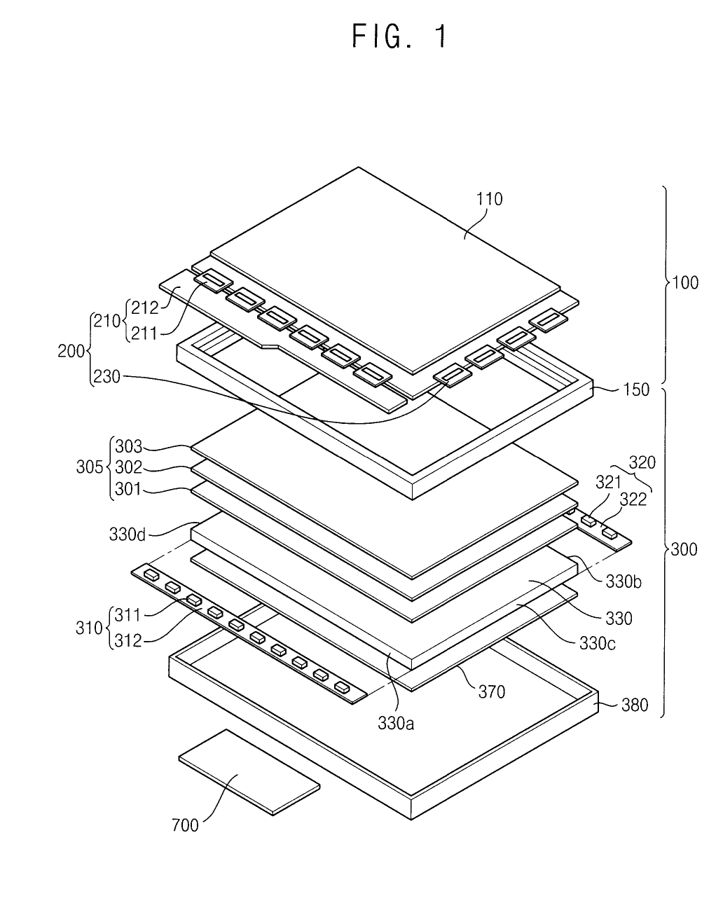

FIG. 1 is an exploded perspective view of an exemplary embodiment of a display apparatus according to the present invention.

Referring to FIG. 1, the display apparatus includes a panel module 100 and a light source module 300.

The panel module 100 includes a display panel 110, a panel driving part 200 and a mold frame 150. The panel driving part 200 may include a data driving part 210 and a gate driving part 230. The data driving part 210 may include a data tape carrier package (“TCP”) 211, on which a data driving chip is mounted, and a source circuit substrate 212 which delivers an external electric signal to the data TCP 211.

The gate driving part 230 may include a gate TCP, on which a gate driving chip is mounted. Alternatively, the gate driving part 230 may be mounted on the display panel 110 in a chip type, or may be integrated into the display panel 110 during a manufacturing process thereof.

The mold frame 150 has a frame shape, e.g., a rectilinear shape, as shown in FIG. 1. A supporting surface, which supports an edge portion of the display panel 110, is formed on the mold frame 150. Thus, the mold frame 150 supports the display panel 110 to fix the display panel 110 therein. In additional exemplary embodiments, the mold frame 150 may be omitted. In yet another exemplary embodiment, the mold frame 150 may be replaced with a pair of side molds (not shown) that are disposed corresponding to corners of the display panel 110. Moreover, the side molds may correspond to opposite corners of the display panel 110, but additional exemplary embodiments are not limited thereto.

Still referring to FIG. 1, the light source module 300 includes a first light-emitting module 310, a second light-emitting module 320, a light guide plate 330 and a reflection plate 370. The first light-emitting module 310 is disposed adjacent to a first edge 330a of the light guide plate 330. The first light-emitting module 310 includes at least one light-emitting diode 311 and a printed circuit board 312 on which the light-emitting diode 311 (or a plurality thereof) is mounted. The second light-emitting module 320 is disposed adjacent to a second edge 330b, opposite to the first edge 330a, of the light guide plate 330. A third edge 330c and a fourth edge 330d, disposed opposite the third edge 330c, connect the first edge 330a and the second edge 330b to form a periphery of the light guide plate 330, as shown in FIG. 1. The second light-emitting module 320 includes at least one light-emitting diode 321 and a printed circuit board 322 on which the light-emitting diode 321 (or a plurality thereof) is mounted.

The light guide plate 330 guides light generated from the first light-emitting module 310 and the second light-emitting module 320 toward the display panel 110. The reflection plate 370 is disposed between the light guide plate 330 and the receiving container 380 to reflect light that leaks from the light guide plate 330.

In one or more exemplary embodiments, the light source module 300 may further include optical sheets 305 and the receiving container 380.

The optical sheets 305 may include a diffusion plate 301, a prism sheet 302 and/or a light condensing sheet 303, as shown in FIG. 1, but additional exemplary embodiments are not limited thereto. The receiving container 380 receives the first light-emitting module 310 and the second light-emitting module 320, the light guide plate 330 and the reflection plate 370, for example. The receiving container 380 may be a bottom chassis 380.

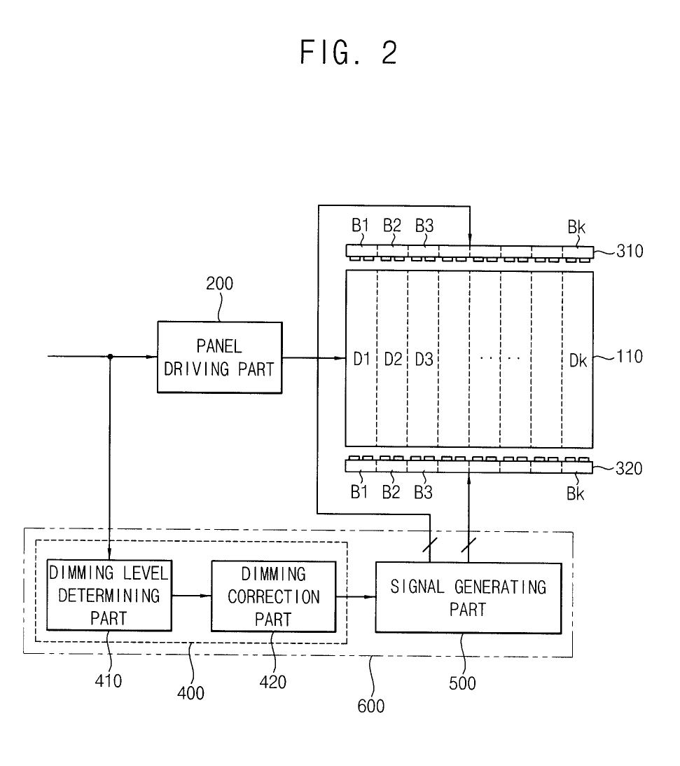

The display apparatus may further include a driving circuit substrate 700, on which a light source driving part 600 (FIG. 2) is mounted. The light source driving part 600 drives the first light-emitting module 310 and the second light-emitting module 320. The driving circuit substrate 700 may be disposed on or near a rear surface of the receiving container 380.

FIG. 2 is a block diagram of the display apparatus of FIG. 1.

Referring to FIGS. 1 and 2, the display apparatus includes the display panel 110, the panel driving part 200, the first light-emitting module 310, the second light-emitting module 320 and the light source driving part 600.

The display panel 110 includes a plurality of pixels that display images. In an exemplary embodiment, for example, a number of pixels is M×N (wherein ‘M’ and ‘N’ are natural numbers). Each of the pixels includes a switching element (not shown) connected to a corresponding gate line (not shown) and a corresponding data line (not shown), a liquid crystal capacitor (not shown) connected to the switching element, and a storage capacitor (not shown) connected to the switching element.

The panel driving part 200 drives the display panel 110. Specifically, for example, the panel driving part 200 according to an exemplary embodiment includes a timing control part (not shown) that controls a driving timing of the display panel 110, the data driving part 210, which outputs a data voltage to the display panel 110, and a gate driving part 230 that outputs a gate signal to the display panel 110 in synchronization with an output timing of the data driving part 210.

The first light-emitting module 310 includes first through k-th light-emitting blocks B1, B2, B3, . . . , Bk, which provide first through k-th display blocks D1, D2, D3, . . . , Dk, respectively, of the display panel 110 with light. In an exemplary embodiment, ‘k’ is a natural number. Similarly, the second light-emitting module 320 includes first through k-th light-emitting blocks B1, B2, B3, . . . , Bk that provide the first through k-th display blocks D1, D2, D3, . . . , Dk, respectively, of the display panel 110 with light.

As shown in FIG. 2, the light source driving part 600 includes a dimming driving part 400 and a signal generating part 500. The dimming driving part 400 includes a dimming level determining part 410 and a dimming correction part 420.

The dimming level determining part 410 divides a frame image, received from an external source (not shown), into first through k-th image blocks corresponding to the first through k-th light-emitting blocks B1, B2, B3, . . . , Bk of both the first light-emitting module 310 and the second light-emitting module 320, and obtains first through k-th representative values of the first through k-th image blocks based on gradations of each of the first through k-th image blocks. The dimming level determining part 410 determines first through k-th dimming levels based on the first through k-th representative values. The dimming level may be a duty ratio level or a luminance level.

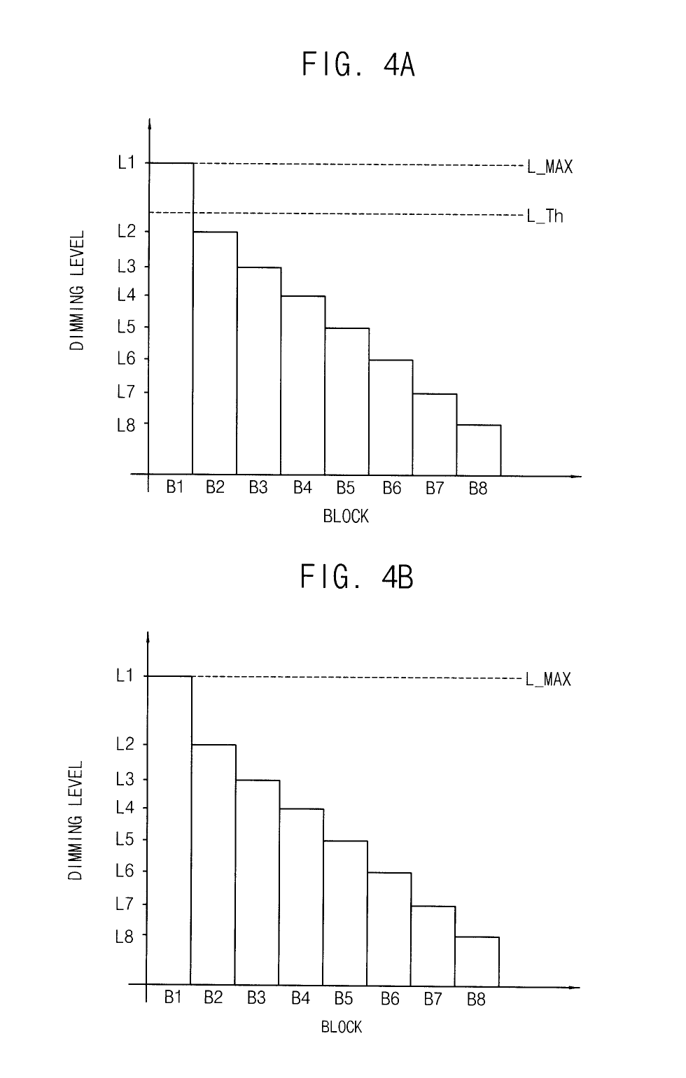

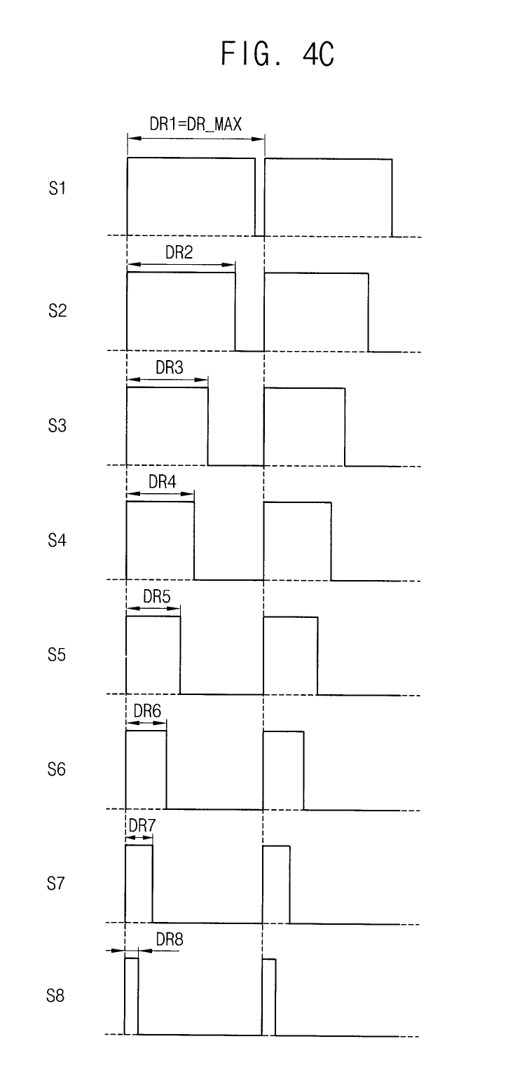

The dimming correction part 420 corrects a dimming level of at least one of the first through k-th dimming levels, which is/are greater than a threshold level L_Th (FIG. 4A). More specifically, for example, the dimming correction part 420 corrects a dimming level of a given light-emitting block B, which provides light to a display block D in which a high gradation image, e.g., an image that has a gradation higher than a set gradation, is displayed, so that a luminance level of the display block D in which the high gradation image is displayed is set to be a minimum white level MIN_WHITE (not shown). In an exemplary embodiment, for example, the set gradation may be a gradation of no more than 240 (for an 8-bit signal). The set gradation may be set in accordance with an algorithm, for example, but additional exemplary embodiments are not limited thereto.

The dimming correction part 420 substantially reduces and/or effectively prevents flicker from being generated due to a luminance level difference of the display block that displays the high gradation image. Moreover, a dimming level that is greater than the threshold level L_Th is decreased to a dimming level corresponding to the minimum white level MIN_WHITE, and power consumption required for driving the light source module 300 is significantly reduced. Hereinafter, for purposes of explanation, displaying a white image will be described in further detail, but it will be noted that additional exemplary embodiments are not limited thereto.

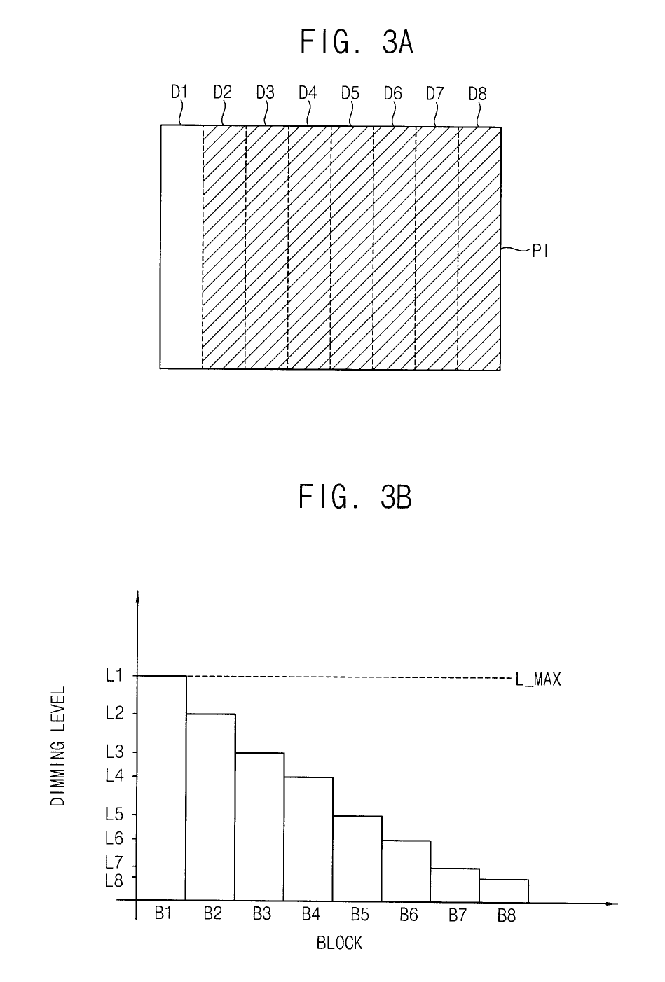

In an exemplary embodiment, the dimming correction part 420 compares each of the first through k-th dimming levels with the threshold level L_Th (FIG. 4A), and detects a light-emitting block B having a high dimming level that is greater than the threshold level L_Th, e.g., a first light-emitting block B1, as shown in FIG. 4A (which will be described in greater detail below). The dimming correction part 420 obtains a set level in accordance with a number of the detected light-emitting blocks B and a position or positions thereof The dimming correction part 420 subtracts the set level from a maximum dimming level L_MAX to calculate a correction dimming level, and corrects a dimming level of the detected light-emitting block as the correction dimming level. A real luminance level of a light-emitting block, in which the correction dimming level is adapted, has a minimum white level MIN_WHITE, as will be described in further detail below with reference to FIGS. 3A and 3B.

The signal generating part 500 generates first through k-th driving signals for driving the first through k-th light-emitting blocks B1, B2, B3, . . . , Bk, respectively, by using first through k-th dimming levels provided from the dimming driving part 400. Each of the first through k-th driving signals is provided to the first light-emitting module 310 and the second light-emitting module 320.

In an exemplary embodiment, the first through k-th light-emitting blocks B1, B2, B3, . . . , Bk are arranged in a one-dimensional structure, e.g., linearly in a single column or row (as shown in FIG. 2), and the first through k-th light-emitting blocks B1, B2, B3, . . . , Bk are thereby driven in a one-dimensional dimming method, e.g., are driven in one column and/or in one row direction, rather than in a two-dimensional method (such as in a matrix of columns and/or rows, described below), in accordance with the first through k-th image blocks displayed on the first through k-th display blocks D1, D2, D3, . . . , Dk.

FIGS. 3A and 3B are graphs of dimming level versus light-emitting block numbers showing luminance levels of a pattern image displayed on the display apparatus of FIG. 1.

Referring to FIG. 3A, a pattern image PI is displayed on the display panel 110. The pattern image PI displays a white image (indicated by the unshaded portion) on the first display block D1, and displays a black image (indicated by the shaded portions) on a second display block D2, a third display block D3, a fourth display block D4, a fifth display block D5, a sixth display block D6, a seventh display block D7 and an eighth display block D8.

The first through eighth light-emitting blocks B1, B2, B3, B4, B5, B6, B7 and B8, corresponding to the first through eighth display blocks D1, D2, D3, D4, D5, D6, D7 and D8, respectively, have corresponding dimming levels shown in FIG. 3B, in accordance with the pattern image PI of FIG. 3A. Specifically, the first light-emitting block B1, corresponding to the first display block D1, emits light based on a first dimming level L1 having the maximum dimming level L_MAX, and the second through eighth light-emitting blocks B2, B3, B4, B5, B6, B7 and B8 corresponding to the remaining second through eighth display blocks D2, D3, D4, D5, D6, D7 and D8 emit light based on second through eighth dimming levels L2, L3, L4, L5, L6, L7 and L8, respectively, which gradually decrease with respect to the maximum dimming level L_MAX. Thus, a real luminance level of a white image displayed on the first display block D1 is determined by luminance levels of the first light-emitting block B1 and the second through eighth light-emitting blocks B2, B3, B4, B5, B6, B7 and B8 adjacent to the first light-emitting block B1.

Thus, when a white image is displayed on one display block B, a real luminance level of the white image displayed on the display block B may be defined as the minimum white level MIN_WHITE. The minimum white level MIN_WHITE may be set in accordance with an algorithm, but additional exemplary embodiments are not limited thereto.

The dimming correction part 420 may be implemented using a logic circuit or, alternatively, a look-up table, but additional exemplary embodiments are not limited thereto. For example, in an additional exemplary embodiment, the dimming correction part 420 may be implemented using the logic circuit together with the look-up table. A plurality of set levels may be stored in the look-up table, described in greater below with reference to Table 1, in accordance with the number of light-emitting blocks B having a dimming level higher than the threshold level L_Th, and a position of the light-emitting blocks B in the display panel 110. For example, when a number of the light-emitting blocks is k, a number of the set levels may be 2^{k}.

Table 1 illustrates an exemplary embodiment of a lookup table having 256 (=2⁸) addresses when the number of light-emitting blocks is eight, e.g., k is equal to eight (8).

TABLE 1

| Address | Set Level | Address | Set Level |
|---|---|---|---|
| 00000000 | None | . . . | . . . |
| 00000001 | None | 00010000 | None |
| 00000010 | None | . . . | . . . |
| 00000011 | B | 00111100 | J |
| . . . | . . . | . . . | . . . |
| 00000111 | G | 11111111 | P |

Referring to Table 1, each of the first through eighth light-emitting blocks B1, B2, B3, B4, B5, B6, B7 and B8 corresponds to first through eighth dimming levels. A bit value of the address may be obtained by comparing the first through eighth dimming levels with the threshold level L_Th. More particularly, the bit value of the address is “1” when the first through eighth dimming levels are greater than the threshold level L_Th, and the bit value of the address is “0” when the first through eighth dimming levels are less than the threshold level L_Th. Specifically, for example, when the address is “00000011,” the first and second dimming levels of the first and second light-emitting blocks B1 and B2 are greater than the threshold level L_Th, and the set level is “B.” Thus, a value, in which the set level “B” is subtracted from the maximum dimming level L_MAX, may be determined as a correction dimming level of the first and second light-emitting blocks B1 and B2, as will be described in greater detail below. In an exemplary embodiment, “B,” “G,” “J” and “P” are natural numbers.

According to Table 1, when the address is “00000000,” the set level does not exist. Specifically, when the first through eighth dimming levels are less than the threshold level L_Th, a white image is not displayed on the display panel 110, and it is not necessary to correct the first through eighth dimming levels. Moreover, when one of the first through eighth dimming levels is greater than the threshold level L_Th, e.g., when one of the bits of the address is “1” (e.g., “00000001,” “00000010,” “00010000,” etc.), a real luminance level of the white image displayed on the display panel 110 is the minimum white level MN_WHITE and it is not necessary to correct the first through eighth dimming levels.

FIGS. 4A, 4B and 4C are graphs of dimming level versus light-emitting block numbers, and duty ratios for corresponding driving signals, illustrating an exemplary embodiment of a method of driving a light source module according to the present invention.

Referring to FIGS. 2 and 4A, the dimming level determining part 410 determines first through eighth dimming levels L1, L2, L3, L4, L5, L6, L7 and L8 of the first through eighth light-emitting blocks B1, B2, B3, B4, B5, B6, B7 and B8 of the dimming level determining part 410. As shown in FIG. 4A, a first dimming level L1 has the maximum dimming level L_MAX, and the remaining second through eighth dimming levels L2, L3, L4, L5, L6, L7 and L8 gradually decrease with respect to the maximum dimming level L_MAX. Put another way, in FIG. 4A, only the first dimming level L1 is only greater than the threshold level L_Th.

When one of the first through eighth dimming levels L1, L2, L3, L4, L5, L6, L7 and L8 is greater than the threshold level L_Th, a real luminance level of the white image displayed on the display panel 110 may have the minimum white level MIN_WHITE.

Referring to FIG. 4B, only the first dimming level L1 is greater than the threshold level L_Th, and the dimming correction part 420 thereby determines that a real luminance level of the image displayed on the display panel 110 is the minimum white level MIN_WHITE. The dimming correction part 420 determines that the first dimming level L1 is a correction dimming level L1 of the first light-emitting block B1. Thus, the dimming correction part 420 provides the signal generating part 500 with first through eighth correction dimming levels L1, L2, L3, L4, L5, L6, L7 and L8.

Referring to FIG. 4C, the signal generating part 500 generates first through eighth driving signals S1, S2, S3, . . . , S8 based on the first through eighth correction dimming levels L1, L2, L3, L4, L5, L6, L7 and L8. A first duty ratio DR1 of the first driving signal S1 has a maximum duty ratio DR_MAX based on the maximum dimming level L_MAX. The second through eighth driving signals S2, S3, S4, S5, S6, S7 and S8 have second through eighth duty ratios DR2, DR3, DR4, DR5, DR6, DR7 and DR8, respectively.

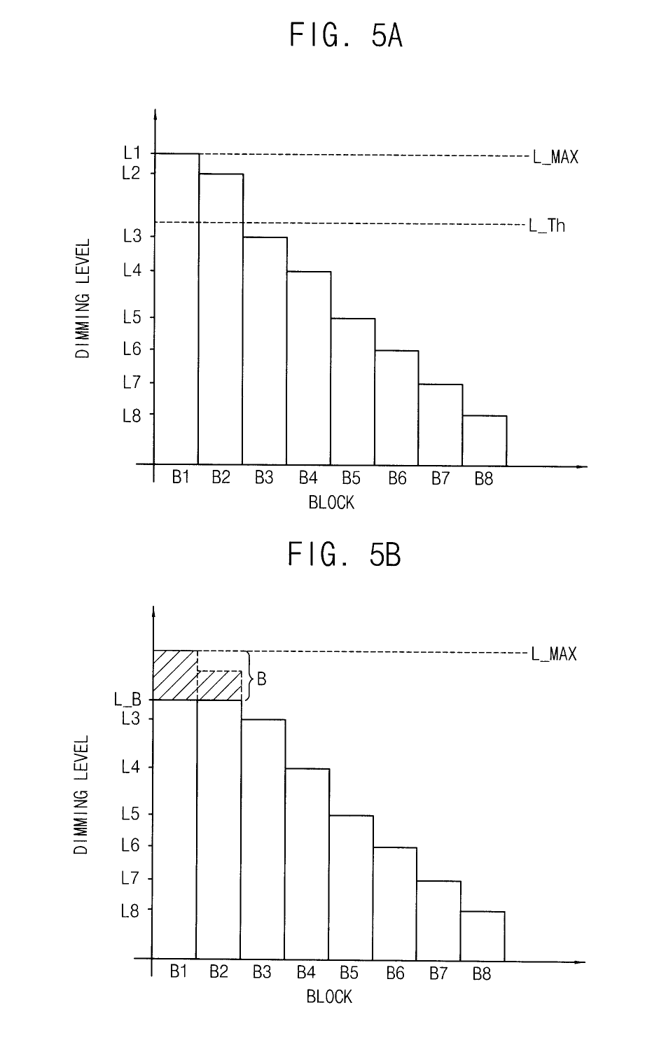

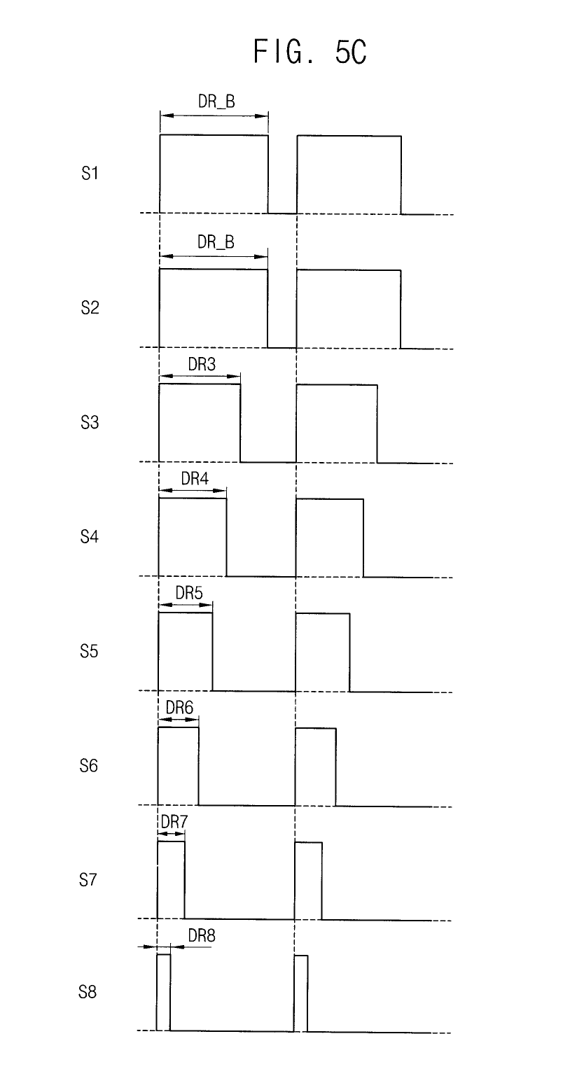

FIGS. 5A, 5B and 5C are graphs of dimming level versus light-emitting block numbers, and duty ratios for corresponding driving signals, illustrating another exemplary embodiment of a method of driving a light source module according to the present invention.

Referring to FIGS. 2 and 5A, the dimming level determining part 410 determines first through eighth dimming levels L1, L2, L3, L4, L5, L6, L7 and L8 of the first through eighth light-emitting blocks B1, B2, B3, B4, B5, B6, B7 and B8. As shown in FIG. 5A, the first and second dimming levels L1 and L2 are greater than the threshold level L_Th, and the remaining third through eighth dimming levels L3, L4, L5, L6, L7 and L8 are less than the threshold level L_Th.

Referring to FIG. 5B, the dimming correction part 420 corrects the first and second dimming levels L1 and L2 so that a real luminance level of an image displayed on the first and second display blocks D1 and D2, corresponding to the first and second dimming levels L1 and L2 that are greater than the threshold levels L_Th, is the minimum white level MN_WHITE. For example, referring to the look-up table shown in Table 1, a set level for correcting the first and second dimming levels L1 and L2 may be “B.”

The dimming correction part 420 obtains the set level “B” by using the look-up table, and then subtracts the set level “B” from the maximum dimming level L_MAX to determine a correction dimming level L_B of the first and second dimming levels L1 and L2. The dimming correction part 420 does not correct the third through eighth dimming levels L3, L4, L5, L6, L7 and L8 that are less than the threshold level L_Th.

The dimming correction part 420 provides the signal generating part 500 with the correction dimming level L_B and the third through eighth dimming levels L3, L4, L5, L6, L7 and L8.

Referring to FIG. 5C, the signal generating part 500 generates first and second driving signals S1 and S2 based on the correction dimming level L_B. Each of the first and second driving signals S1 and S2 has a duty ratio DRB corresponding to the correction dimming level L_B. The signal generating part 500 generates third through eighth driving signals S3, S4, S5, S6, S7 and S8 based on the third through eighth dimming level L3, L4, L5, L6, L7 and L8. The third through eighth driving signals S3, S4, S5, S6, S7 and S8 have duty ratio DR3, DR4, DR5, DR6, DR7 and DR8, respectively as shown in FIG. 5C.

Consequently, the first and second light-emitting blocks B1 and B2 are operated by, e.g., are driven by, an identical driving signal, and thus a real luminance level of the first and second display blocks D1 and D2 that receive light from the first and second light-emitting blocks B1 and B2, respectively, is the minimum white level MIN_WHITE.

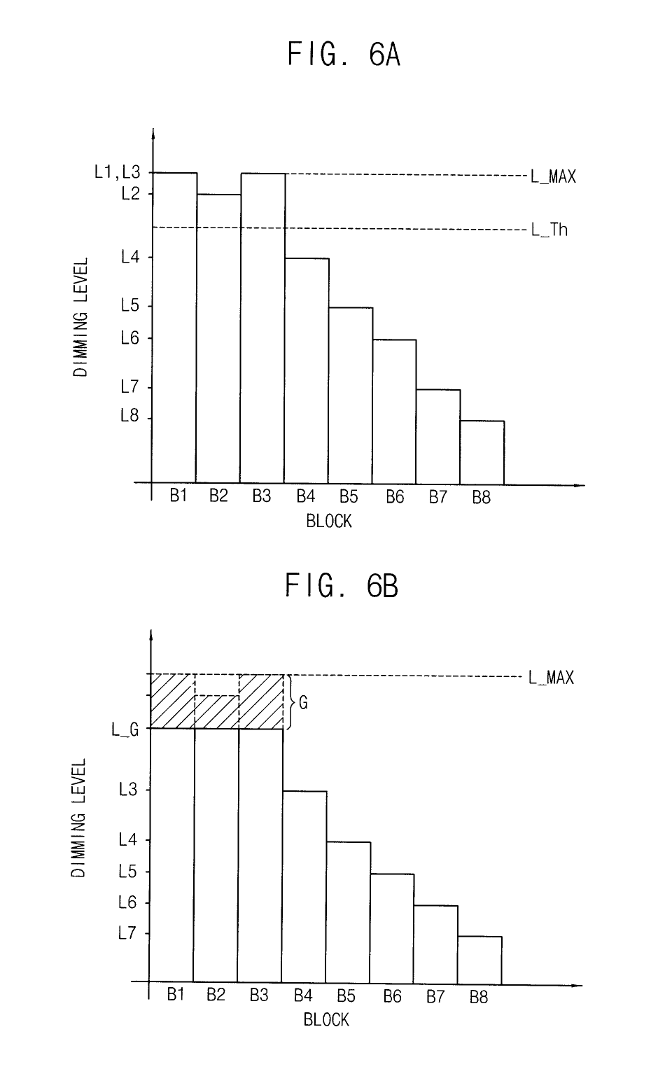

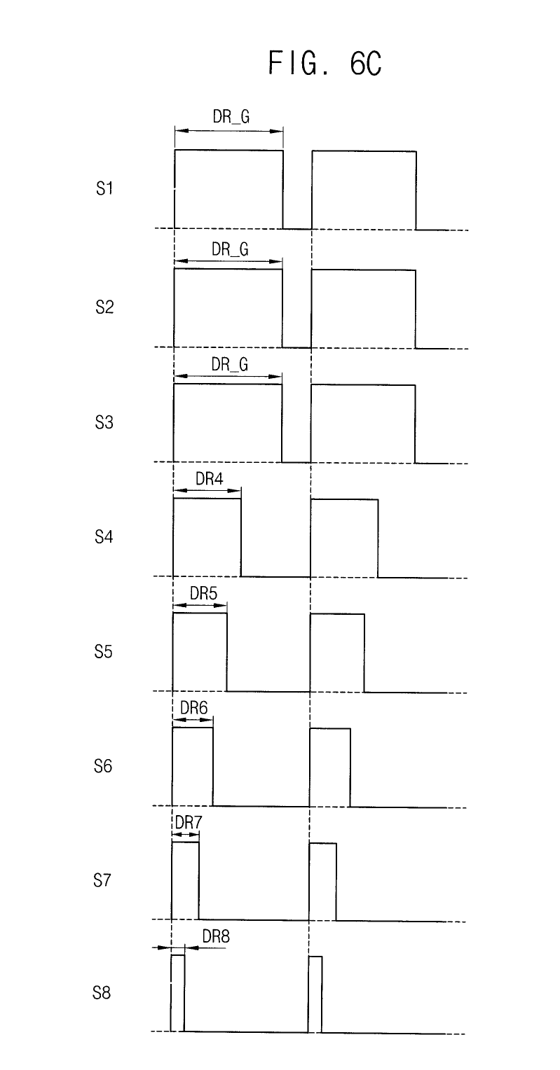

FIGS. 6A, 6B and 6C are graphs of dimming level versus light-emitting block numbers, and duty ratios for corresponding driving signals, illustrating another exemplary embodiment of a method of driving a light source module according to the present invention.

Referring to FIGS. 2 and 6A, the dimming level determining part 410 determines first through eighth dimming levels L1, L2, L3, L4, L5, L6, L7 and L8 of the first through eighth light-emitting blocks B1, B2, B3, B4, B5, B6, B7 and B8. As shown in FIG. 6A, the first, second and third dimming levels L1, L2 and L3 are greater than the threshold level L_Th, and the remaining fourth through eighth dimming levels L4, L5, L6, L7 and L8 are less than the threshold level L_Th.

Referring to FIG. 6B, the dimming correction part 420 corrects the first, second and third dimming levels L1, L2 and L3 so that a real luminance level of an image displayed on the first, second and third display blocks D1, D2 and D3, corresponding to the first, second and third dimming levels L1, L2 and L3, respectively, that are greater than the threshold levels L_Th, is the minimum white level MIN_WHITE. For example, referring to the look-up table of Table 1, a set level for correcting the first, second and third dimming levels L1, L2 and L3 may be “G.”

The dimming correction part 420 obtains the set level “G” by using the look-up table, and then subtracts the set level “G” from the maximum dimming level L_MAX to determine a correction dimming level L_G of the first, second and third dimming levels L1, L2 and L3. The dimming correction part 420 does not correct the fourth through eighth dimming levels L4, L5, L6, L7 and L8 that are less than the threshold level L_Th.

The dimming correction part 420 provides the signal generating part 500 with the correction dimming level L_G and the fourth through eighth dimming levels L4, L5, L6, L7 and L8.

Referring to FIG. 6C, the signal generating part 500 generates first, second and third driving signals S1, S2 and S3 based on the correction dimming level L_G. The first, second and third driving signals S1, S2 and S3 each have a duty ratio DR_G corresponding to the correction dimming level L_G The signal generating part 500 generates fourth through eighth driving signals S4, S5, S6, S7 and S8 based on the fourth through eighth dimming level L4, L5, L6, L7 and L8, respectively. The fourth through eighth driving signals S4, S5, S6, S7 and S8 have fourth through eighth duty ratios DR4, DR5, DR6, DR7 and DR8, respectively.

Consequently, the first, second and third light-emitting blocks B1, B2 and B3 are operated by, e.g., are driven by, an identical driving signal, and thus a real luminance level of the first, second and third display blocks D1, D2 and D3 that receive light from the first, second and third light-emitting blocks B1, B2 and B3 may be the minimum white level MN_WHITE.

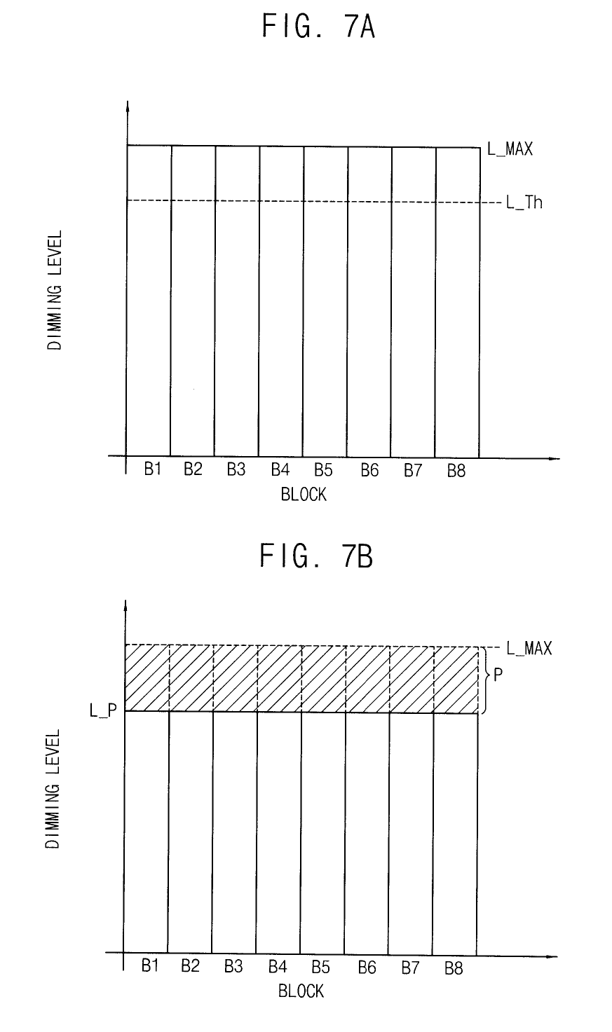

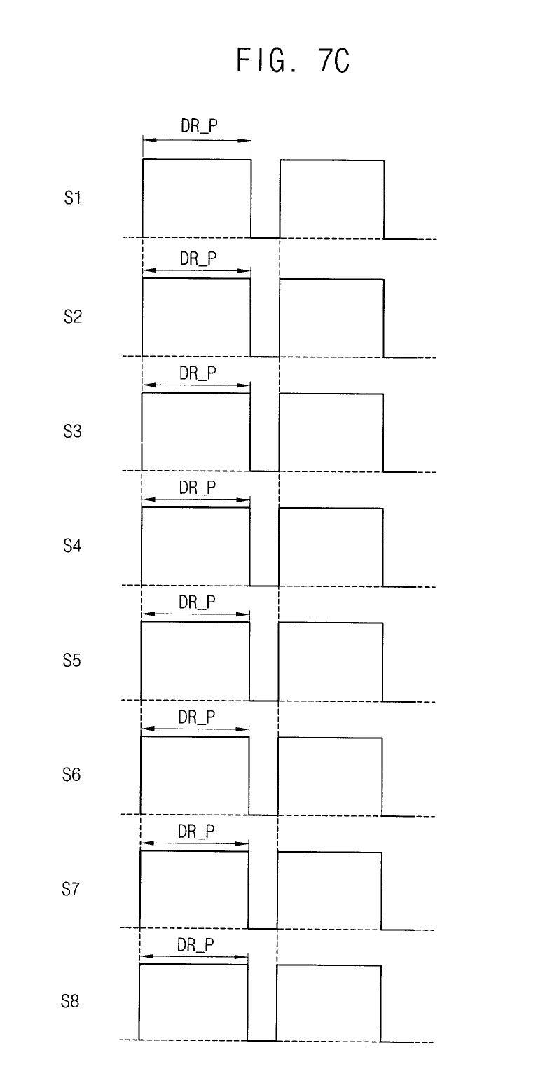

FIGS. 7A, 7B and 7C are graphs of dimming level versus light-emitting block numbers, and duty ratios for corresponding driving signals, illustrating yet another exemplary embodiment of a method of driving a light source module according to the present invention.

Referring to FIGS. 2 and 7A, the dimming level determining part 410 determines first through eighth dimming levels L1, L2, L3, L4, L5, L6, L7 and L8 of first through eighth light-emitting blocks B1, B2, B3, B4, B5, B6, B7 and B8. All of the first through eighth dimming levels L1, L2, L3, L4, L5, L6, L7 and L8 are greater than the threshold level L_Th. When the display panel 110 is driven in a full white mode, all of the first through eighth dimming levels L1, L2, L3, L4, L5, L6, L7 and L8 have the maximum dimming level L_MAX.

When the first through eighth light-emitting blocks B1, B2, B3, B4, B5, B6, B7 and B8 are driven using the maximum dimming level L_MAX, a real luminance level of the display panel 110 has the maximum luminance level MAX_WHITE that is greater than the minimum white level MN_WHITE. Each of the first through eighth light-emitting blocks B1, B2, B3, . . . , B8 may be influenced by a luminance level of adjacent light-emitting blocks B, and thus luminance levels of the adjacent light-emitting blocks B may be accumulated so that the display panel 110 may have the maximum white level MAX_WHITE that is greater than the minimum white level MIN_WHITE.

Referring to FIG. 7B, the dimming correction part 420 corrects a real dimming luminance level of the display panel 110 driving in the full white mode into the minimum white level MN_WHITE by correcting the first through eighth dimming levels L1, L2, L3, L4, L5, L6, L7 and L8 having the maximum dimming level L_MAX. Specifically, referring to Table 1, for example, the dimming correction part 420 obtains a set level “P” corresponding to the address “11111111.”

The dimming correction part 420 subtracts the set level “P” from the maximum dimming level L_MAX to determine a correction dimming level L_P of the first through eighth light-emitting blocks B1, B2, B3, B4, B5, B6, B7 and B8.

The dimming correction part 420 provides the signal generating part 500 with the correction dimming level L_P.

Referring to FIG. 7C, the signal generating part 500 generates first through eighth driving signals S1, S2, S3, S4, S5, S6, S7 and S8 based on the correction dimming level L_P. Each of the first through eighth driving signals S1, S2, S3, B4, B5, B6, B7 and S8 has a duty ratio DR_P corresponding to the correction dimming level L_P.

Consequently, the first through eighth light-emitting blocks B1, B2, B3, B4, B5, B6, B7 and B8 are operated by, e.g., are driven by, an identical driving signal, and thus a real luminance level of the display panel 110 receiving lights from the first through eighth light-emitting blocks B1, B2, B3, B4, B5, B6, B7 and B8 may be the minimum white level MN_WHITE.

Therefore, the real luminance level of the white image displayed on the display panel 110 is uniformed to the minimum white level MN_WHITE, and flicker due to a luminance level difference of the white image is substantially reduced and/or is effectively prevented. Moreover, when the display panel 110 is driven in the full white mode, power consumption required for driving the light source module 300 is significantly reduced.

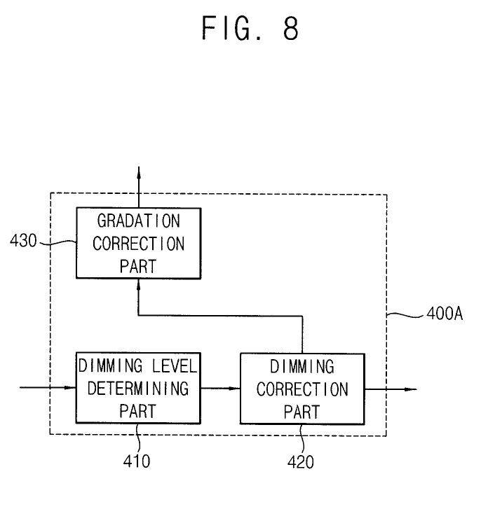

FIG. 8 is a block diagram of another exemplary embodiment of a dimming driving part according to the present invention. The display apparatus according to the exemplary embodiment shown in FIG. 8 is substantially the same as the display apparatus described in greater above with reference to FIGS. 1 through 7C, except for a dimming driving part 400A. Thus, the same reference characters are used in FIG. 8 to refer to same or like components as those shown in FIGS. 1 through 7C, and any repetitive detailed description thereof will hereinafter be omitted.

Referring to FIGS. 2 and 8, the dimming driving part 400A includes a dimming level determining part 410, a dimming correction part 420 and a gradation correction part 430.

The dimming level determining part 410 obtains first through k-th representative values of the first through k-th image blocks D1, D2, D3, . . . , Dk corresponding to the first through k-th light-emitting blocks B1, B2, B3, . . . , Bk by using a frame image received from an external source (not shown). In an exemplary embodiment, ‘k’ is a natural number. The dimming level determining part 410 determines first through k-th dimming levels based on the first through k-th representative values. The dimming level may be a duty ratio level or a luminance level, but additional exemplary embodiments are not limited thereto.

The dimming correction part 420 corrects a dimming level or levels of the first through k-th dimming levels, which is/are greater than a threshold level L_Th, so that a real luminance level of a light-emitting block B corresponding to the dimming level or levels greater than the threshold level L_Th is the minimum white level MIN_WHITE. Thus, the dimming correction part 420 effectively prevents flicker from being generated due to a luminance level difference of the white image displayed on the display panel 110. Moreover, a dimming level that is greater than the threshold level L_Th is decreased, and power consumption required for driving the light source module 300 is substantially reduced.

The gradation correction part 430 corrects a gradation of a frame image based on the dimming levels that are corrected by the dimming correction part 420. The gradation correction part 430 corrects gradations of the first image block displayed on the first display block D1 by using a first dimming level, and corrects gradations of the second image block displayed on the second display block D2 by using a second dimming level. Similarly as to described in greater detail above, the gradation correction part 430 corrects gradations of the third through k-th image blocks by using third through k-th dimming levels. For example, when the first light-emitting block B1 emits light having a high luminance, the gradation correction part 430 corrects a gradation of the first image block corresponding to the first light-emitting block B1. Likewise, the gradation correction part 430 controls a gradation voltage level of the display panel 110 in accordance with a luminance level of the light source module 300, and power consumption required for driving the display panel 110 is significantly reduced.

In an exemplary embodiment, a method of driving a light source shown in FIG. 8 is substantially the same as described in greater detail above with reference to FIGS. 4A through 7C, and thus any repetitive detailed description thereof will hereinafter be omitted.

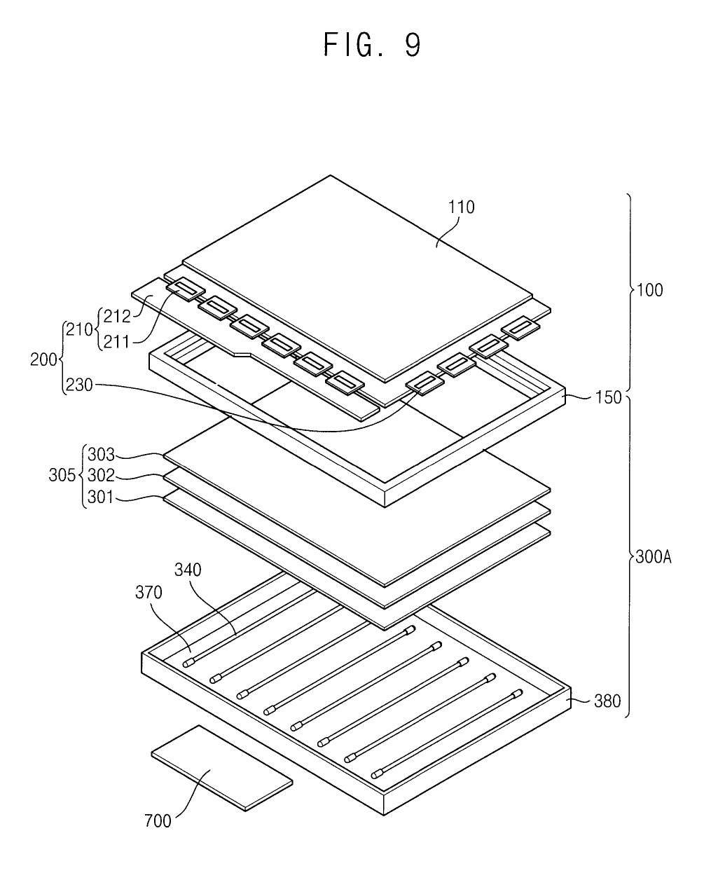

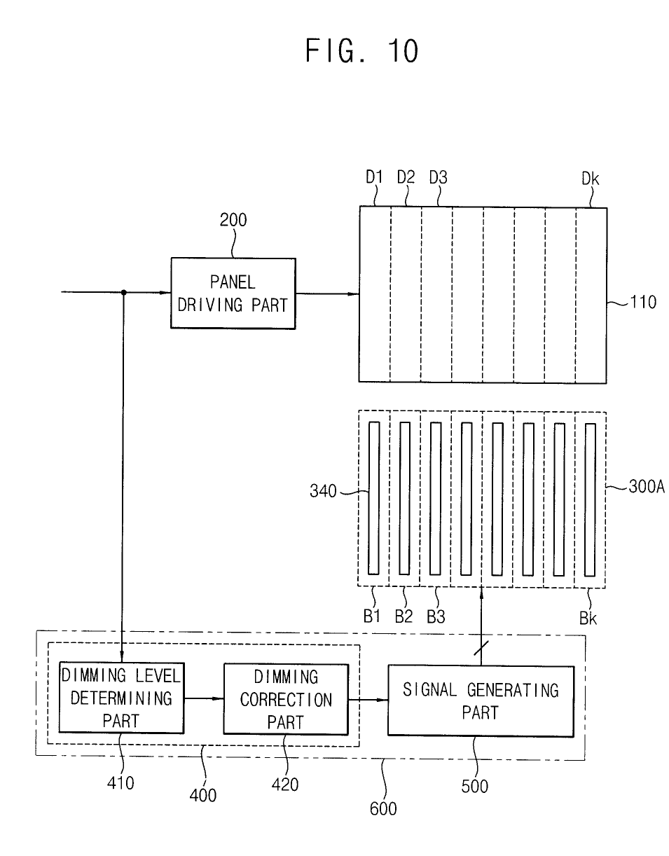

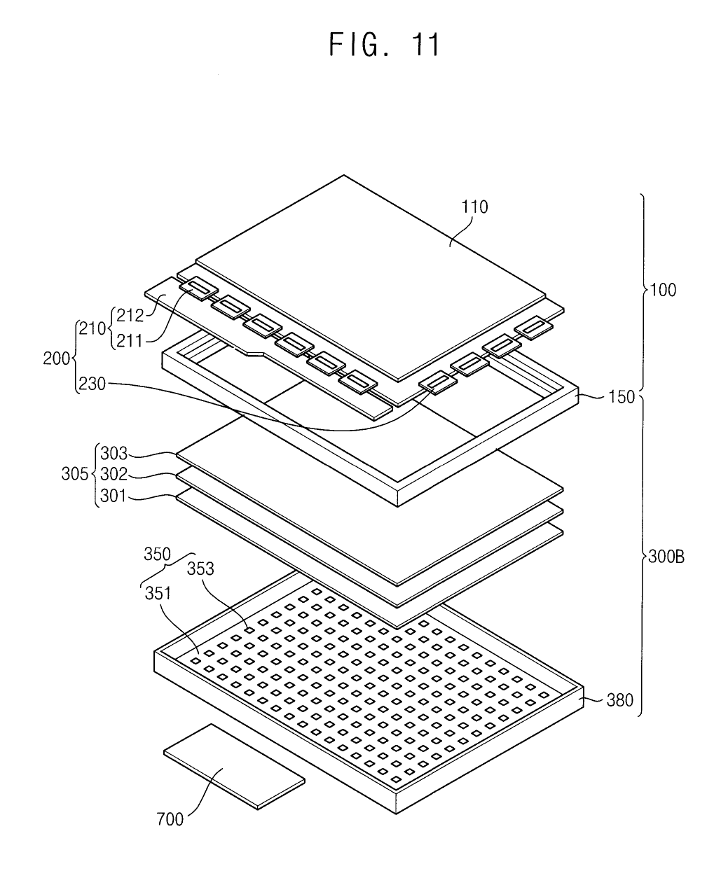

FIG. 9 is an exploded perspective view of another exemplary embodiment of a display apparatus according to the present invention. FIG. 10 is a block diagram of the display apparatus of FIG. 9. Hereinafter, the same reference characters in FIGS. 9 and 12 will be used to refer to the same or like components described in greater detail above, and thus any repetitive detailed explanation will simplified or omitted.

Referring to FIGS. 9 and 10, the display apparatus according to an exemplary embodiment includes a panel module 100 and a light source module 300A.

The panel module 100 includes a display panel 110, a panel driving part 200 and a mold frame 150. The panel driving part 200 may include a data driving part 210 and a gate driving part 230 (FIG. 1).

The panel driving part 200 drives the display panel 110. Specifically, for example, the panel driving part 200 includes a timing control part (not shown) that controls a driving timing of the display panel 110, the data driving part 210 that outputs a data voltage to the display panel 110 and the gate driving part 230 that outputs a gate signal to the display panel 110 in synchronization with an output timing of the data driving part 210.

The light source module 300A includes a plurality of lamps 340, a reflection plate 370 and a receiving container 380. Lamps 340 of the plurality of lamps 340 are arranged on, e.g., are disposed on, the reflection plate 370 and generate light. The reflection plate 370 is disposed on a lower surface, e.g., a bottom surface, of the receiving container 380 to reflect the light generated from the lamps 340. In one or more exemplary embodiments, the light source module 300 may further include a plurality of optical sheets 305.

The light source module 300A is divided into first through k-th light-emitting blocks B1, B2, B3, . . . , Bk corresponding to the lamps 340. Each of the light-emitting blocks includes at least one lamp 340. The first through k-th light emitting blocks B1, B2, B3, . . . , Bk provide the first through k-th display blocks D1, D2, D3, . . . , Dk with light.

The light source driving part 600 includes a dimming driving part 400 and a signal generating part 500. The dimming driving part 400 includes a dimming level determining part 410 and a dimming correction part 420.

The dimming level determining part 410 obtains first through k-th representative values of the first through k-th image blocks corresponding to first through k-th light-emitting blocks B1, B2, B3, . . . , Bk (wherein ‘k’ is a natural number). The dimming level determining part 410 determines first through k-th dimming levels based on the first through k-th representative values. The dimming level may be a duty ratio level or a luminance level, but additional exemplary embodiments are not limited thereto.

The dimming correction part 420 corrects a dimming level that is greater than a threshold level L_Th of the first through k-th dimming levels. For example, the dimming correction part 420 may correct a dimming level of a light-emitting block B, which provides light to a display block D in which a white image that has a greater gradation than a set gradation is displayed, so that a luminance level of the display block B on which the white image is displayed is to a minimum white level MIN_WHITE. Accordingly, the dimming correction part 420 effectively prevents flicker from being generated due to a luminance level difference of the white image displayed on the display panel 110. Moreover, a dimming level that is greater than the threshold level L_Th is decreased, so that power consumption required for driving the light source module 300 is substantially reduced.

The signal generating part 500 generates first through k-th driving signals for driving the first through k-th light-emitting blocks B1, B2, B3, . . . , Bk by using first through k-th dimming levels provided from the dimming driving part 400.

Consequently, the first through k-th light-emitting blocks B1, B2, B3, . . . , Bk are driven in a one-dimensional dimming method, e.g., are driven in one column and/or in one row, rather than in a two-dimensional method (such as in a matrix of columns and/or rows), in accordance with the first through k-th image blocks displayed on the first through k-th display blocks D1, D2, D3, . . . , Dk.

Moreover, the light source driving part 600 may include a dimming driving part 400A including a gradation correction part 430, as shown in FIG. 8.

A method of driving the light source shown in FIGS. 9 and 10 is substantially the same as described in greater detail above with reference to FIGS. 4A through 7C, and thus any repetitive detailed explanation will hereinafter be omitted.

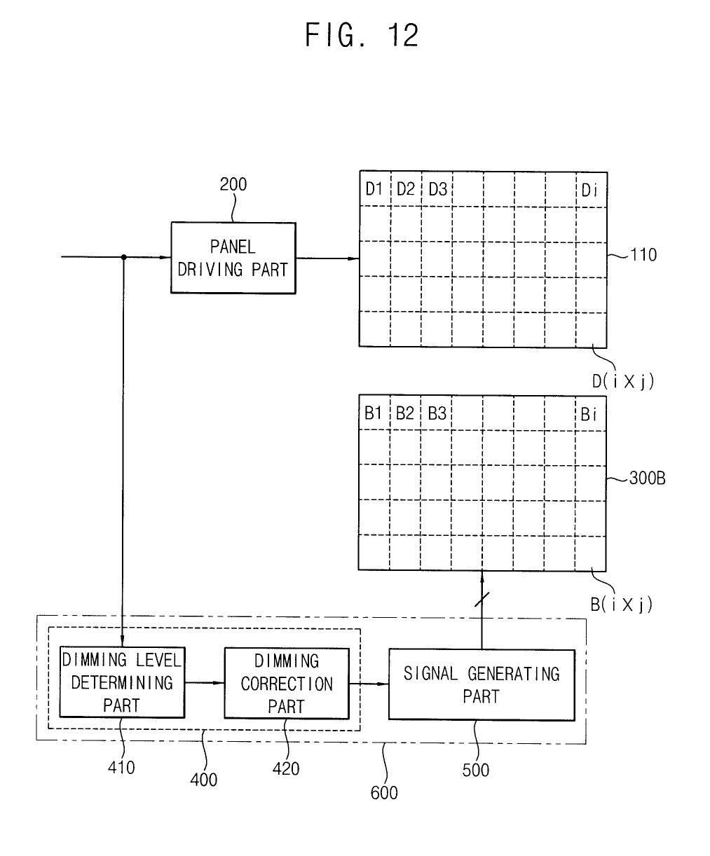

FIG. 11 is an exploded perspective view of yet another exemplary embodiment of a display apparatus according to the present invention. FIG. 12 is a block diagram of the display apparatus of FIG. 11. Hereinafter, the same reference characters in FIGS. 11 and 12 refer to the same or like components described in greater detail above, and thus any repetitive detailed explanation will be simplified or omitted.

Referring to FIGS. 11 and 12, the display apparatus according to an exemplary embodiment includes a panel module 100 and a light source module 300B.

The panel module 100 includes a display panel 110, a panel driving part 200 and a mold frame 150. The panel driving part 200 may include a data driving part 210 and a gate driving part 230 (FIG. 1).

The panel driving part 200 drives the display panel 110. Specifically, for example, the panel driving part 200 includes a timing control part (not shown) that controls a driving timing of the display panel 110, the data driving part 210 that outputs a data voltage to the display panel 110 and the gate driving part 230 that outputs a gate signal to the display panel 110 in synchronization with an output timing of the data driving part 210.

The light source module 300B includes a light-emitting module 350 and a receiving container 380. The light-emitting module 350 includes a printed circuit board (“PCB”) 351 and a plurality of light-emitting diodes 353 mounted on, e.g., disposed on, the printed circuit board 351. The printed circuit board 351 is disposed on a lower, e.g., bottom, surface of the receiving container 380. The printed circuit board 351 may include a plurality of printed circuit boards. In an exemplary embodiment, the light source module 300 may further include a plurality of optical sheets 305.

The light source module 300B divides light-emitting diodes 353 into first through (i×j)-th light-emitting blocks B1, B2, B3, . . . , B(i×j). Each of the light-emitting blocks includes at least one light-emitting diode 353. The first through (i×j)-th light-emitting blocks B1, B2, B3, . . . , B(i×j) individually provide first through (i×j)-th display blocks D1, D2, D3, . . . , D(i×j) of the display panel 110 with light. In an exemplary embodiment, ‘i’ and ‘j’ are natural numbers.

The light source driving part 600 includes a dimming driving part 400 and a signal generating part 500. The dimming driving part 400 includes a dimming level determining part 410 and a dimming correction part 420.

The dimming level determining part 410 obtains first through (i×j)-th representative values of the first through (i×j)-th image blocks corresponding to the first through (i×j)-th light-emitting blocks B1, B2, B3, . . . , B(i×j). The dimming level determining part 410 determines first through (i×j)-th dimming levels based on the first through (i×j)-th representative values. The dimming level may be a duty ratio level or a luminance level, but is not particularly limited thereto.

The dimming correction part 420 corrects a dimming level that is greater than a threshold level L_Th of the first through (i×j)-th dimming levels. Thus, the dimming correction part 420 corrects a dimming level of a light-emitting block B that provides light to a display block D in which a white image that has a higher gradation than a predetermined gradation is displayed, so that a luminance level of the display block D that displays the white image is a minimum white level MIN_WHITE. When a white image is displayed on one display block D of first through (i×j)-th display blocks D1, D2, D3, . . . , D(i×j) and a black image is displayed on the remaining display blocks D, the minimum white level may be a real luminance level of the white image displayed on the display panel 110. Moreover, the minimum white level MIN_WHITE may be set in accordance with an algorithm, but additional exemplary embodiments are not limited thereto.

The dimming correction part 420 may be implemented using a logic circuit or in a look-up table. Alternatively, the dimming correction part 420 may be implemented using the logic circuit together with the look-up table. A plurality of set levels may be stored in the look-up table in accordance with the number of light-emitting blocks B having a dimming level higher than the threshold level L_Th and a position of the light-emitting blocks B in the display panel 110. For example, when a number of the light-emitting blocks B is (i×j), a number of the set levels may be 2^{(i×j)}.

In an exemplary embodiment, the dimming correction part 420 effectively prevents flicker from being generated due to a luminance level difference of the white image display on the display panel 110. In addition, a dimming level that is greater than the threshold level L_Th is decreased, so that power consumption required for driving the light source module 300B is substantially reduced.

The signal generating part 500 generates first through (i×j)-th driving signals for driving the first through (i×j)-th light-emitting blocks B1, B2, B3, . . . , B(i×j) by using the first through (i×j)-th dimming levels provided from the dimming driving part 400.

Consequently, the first through (i×j)-th light-emitting blocks B1, B2, B3, . . . , B(i×j) may be driven in a two-dimensional dimming method, e.g., may be driven in a matrix method, in accordance with first through (i×j)-th image blocks displayed on the first through (i×j)-th display blocks D1, D2, D3, . . . , D(i×j).

A method of driving the light source shown in FIGS. 11 and 12 is substantially the same as described above with reference to FIGS. 4A to 7C, and thus any repetitive detailed description will hereinafter be omitted.

In an exemplary embodiment, the light source driving part 600 may include a dimming driving part 400A including the gradation correction part 430, as shown in FIG. 8. For example, the gradation correction part 430 may correct a gradation of the first through (i×j)-th image blocks by using the first through (i×j)-th dimming levels that are corrected by the dimming correction part 420.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. A method of driving a light source comprising first through k-th light-emitting blocks, wherein k is a natural number, the first through k-th light-emitting blocks providing a display panel with light, the method comprising:
providing identical driving signals to a plurality of light-emitting blocks of the first through k-th light-emitting blocks on which a high gradation image, which has a gradation greater than a predetermined gradation, is displayed.

2. The method of claim 1, further comprising:
determining first through k-th dimming levels of the first through k-th light-emitting blocks, respectively, based on a gradation of an image displayed on first through k-th display blocks of the display panel;
determining one or more determined light-emitting blocks of the first through k-th light-emitting blocks on which the high gradation image is displayed by comparing the first through k-th dimming levels with a threshold level;
determining a correction dimming level of the one or more determined light-emitting blocks;
generating a driving signal based on the correction dimming level; and
providing the driving signal to the plurality of light-emitting blocks on which the high gradation image is displayed.

3. The method of claim 2, wherein, when one light-emitting block provides light to the display block on which the high gradation image is displayed, the determining the correction dimming level comprises:
using the gradation of the image as the correction dimming level of the determined light-emitting block.

4. The method of claim 2, wherein, when more than one light-emitting block provides light to the display block on which the high gradation image is displayed, the determining the correction dimming level comprises:
obtaining a set level in accordance with a position of the determined light-emitting blocks; and
subtracting the set level from a maximum dimming level.

5. The method of claim 4, wherein the set level is obtained from a look-up table.

6. A method of driving a light source comprising first through k-th light-emitting blocks, wherein k is a natural number, the first through k-th light-emitting blocks respectively providing first through k-th display blocks of the display panel with light, the method comprising:
driving a light-emitting block of the first through k-th light-emitting blocks on which a white image is displayed so that a luminance level of a corresponding display block on which the white image is displayed is a minimum white level,
wherein, when a white image is displayed on one of the first through k-th display blocks and a black image is displayed on remaining display blocks of the first through k-th display blocks, the minimum white level is a luminance level of the corresponding display block on which the white image is displayed.

7. The method of claim 6, further comprising:
determining first through k-th dimming levels of the first through k-th light-emitting blocks, respectively, based on a gradation of an image displayed on the first through k-th display blocks of the display panel;
determining one or more determined light-emitting blocks providing light to the display block on which the white image is displayed by comparing the first through k-th dimming levels with a threshold level;
determining a correction dimming level of the one or more determined light-emitting blocks;
generating a driving signal based the correction dimming level; and
providing the driving signal to the light-emitting block corresponding to the display block on which the white image is displayed.

8. The method of claim 7, wherein, when one light-emitting block provides light to the display block on which the white image is displayed, the determining the correction dimming level comprises:
using the gradation of the image as the correction dimming level of the determined light-emitting block.

9. The method of claim 7, wherein, when more than one light-emitting block provides light to the display block on which the white image is displayed, the determining the correction dimming level comprises:
obtaining a set level in accordance with a position of the determined light-emitting blocks; and
subtracting the set level from a maximum dimming level.

10. A display apparatus comprising:
a display panel which displays an image;
a light source module comprising first through k-th light-emitting blocks, wherein k is a natural number, which provide first through k-th display blocks, respectively, of the display panel with light; and
a light source driving part which provides identical driving signals to a plurality of light-emitting blocks of the first through k-th light-emitting blocks on which a high gradation image, which has a gradation greater than a predetermined gradation, is displayed.

11. The display apparatus of claim 10, wherein the light source driving part comprises:
a dimming level determining part which determines first through k-th dimming levels of the first through k-th light-emitting blocks, respectively, based on a gradation of an image displayed on the first through k-th display blocks;
a dimming correction part which determines one or more determined light-emitting blocks corresponding to a display block on which the high gradation image is displayed by comparing the first through k-th dimming levels with a threshold level, and which generates a correction dimming level of the one or more determined light-emitting blocks; and
a signal generating part which generates a driving signal based on the correction dimming level and which provides the plurality of light-emitting blocks on which the high gradation image is displayed with the driving signal.

12. The display apparatus of claim 11, wherein, when one light-emitting block provides light to the display block on which the high gradation image is displayed, the dimming correction part determines the dimming level which is determined using a gradation of the image as the correction dimming level of the determined light-emitting block.

13. The display apparatus of claim 11, wherein, when more than one light-emitting block provides light to the display block on which the high gradation image is displayed, the dimming correction part obtains a set level in accordance with a position of the determined light-emitting blocks, and subtracts the set level from a maximum dimming level.

14. The display apparatus of claim 13, wherein the dimming correction part obtains the set level from look-up table.

15. The display apparatus of claim 11, wherein the light source driving part further comprises a gradation correction part which corrects a gradation of first through k-th image blocks which are displayed on the first through k-th display blocks, respectively, based on the first through k-th dimming levels.

16. The display apparatus of claim 10, wherein the first through k-th light-emitting blocks are arranged in a one-dimensional structure.

17. The display apparatus of claim 10, wherein the light source module comprises:
a light guide plate;
a first light-emitting module disposed at a first edge of the light guide plate, the first light-emitting module comprising a first light-emitting diode; and
a second light-emitting module disposed at a second edge of the light guide plate, which is opposite to the first edge, the second light-emitting module comprising a second light-emitting diode.

18. The display apparatus of claim 10, wherein each of the first through k-th light-emitting blocks comprises a lamp.

19. The display apparatus of claim 10, wherein the first through k-th light-emitting blocks are arranged in a two-dimensional structure.

20. The display apparatus of claim 19, wherein each of the light-emitting blocks comprises a light-emitting diode.
